(19) United States
(12) Patent Application Publication
(10) Pub. No.: US 2008/0021880 A1
(43) Pub. Date: Jan. 24, 2008

(54) Method and system for highlighting and adding commentary to network web page content

(76) Inventors: Jing Hui Ren, QingDao (CN); Feng Xu, QingDao (CN)

Correspondence Address: MCCORMICK, PAULDING & HUBER LLP, 185 ASYLUM STREET, CITY PLACE II, HARTFORD, CT, 06103, US

(21) Appl. No.: 11/717,393

(22) Filed: Mar. 13, 2007

(30) Foreign Application Priority Data
Jul. 20, 2006 (CN) 200610107537.3

(51) Int. Cl. G06F 17/30

(52) U.S. Cl. 707/3

(57) ABSTRACT

An enhanced web page content search system is implemented on or as part of a web browser application (e.g., as a “plug-in”) for highlighting and adding commentary to web page content displayed on a terminal. The system includes a user interface and a search engine, and provides enhanced search functionality, e.g., flexible formatting, data-type, and other search options. After a user accesses a website and enters search criteria, the search engine conducts a search of the accessed website content. The search results are highlighted at the same time. The user is provided with options for navigating through the search results (e.g., a search index), for adding selected displayed content to the search results and/or for removing selected search results, and for adding comments to the web page content. The highlighted and/or commented web page (including the original web page content and structure) is stored locally for subsequent retrieval and use.

This application is entitled to the benefit of and claims foreign priority under 35 U.S.C. § 119 from Chinese Patent Application No. 200610107537.3, filed Jul. 20, 2006, the disclosure of which is hereby incorporated by reference.

### FIELD OF THE INVENTION

The present invention relates to network communications and, more particularly, to utility services or software applications for viewing Internet web page content.

### BACKGROUND OF THE INVENTION

In Internet-protocol (IP) or other packet data based networks such as the Internet, a number of terminals are directly or indirectly connected to one another for communicating over long distances. (The Internet, in effect, comprises a number of interconnected networks.) The terminals are electronic devices capable of communicating with other devices over a network, and may include, for example, computer terminals and wireless units. Most terminals also include input/output and user control means such as a keyboard, pointing device, and display. For transmitting data from a transmitting terminal to a receiving terminal, data is broken into packets each,addressed to the receiving terminal. The packets are transferred over the network in a distributed manner, e.g., possibly along different paths, with intervening, nodes/terminals forwarding the data along to the receiving terminal according to the address. Once received at the receiving terminal, the packets are reassembled for the receiving terminal to use the data in the packets.

In a common use of the Internet, users access Internet websites for obtaining information, downloading data/files, and communicating with one another, among other functions. A website is a set of encoded data (e.g., HTML encoded data) stored on a server terminal. (Generally speaking, in this context a server terminal is a terminal that hosts a website, typically including resources for high-speed data transmissions, resources for communicating with a number of other terminals, and an “always-on” network connection.) For accessing a website on the Internet, a user directs his or her computer terminal to establish a connection to the Internet, if the terminal is not already connected thereto. Typically, this is done through a commercial ISP (Internet service provider), which provides and maintains the logical and physical connections for accessing the ISP's network and the Internet. Then, the user enters a URI (uniform resource identifier), URL (uniform resource locator), or IP address of the website into a web browser software program running on the computer terminal, e.g., Microsoft Internet Explorer™. The URL is a string of characters conforming to a standardized format, which refers to a resource on the Internet (such as the home page of the website) by its network location, and which may specify the protocol to use to communicate, the host/server to communicate with, the network port on the server to connect to, and the path to the resource on the server (for example, its file name). Once the URL is entered, the server terminal is contacted and, if available, the server terminal transmits requested data back to the user's terminal, according to the particular URL. For example, if the URL is for a website home page, data corresponding to the home page, as stored on the server, is transmitted back to the user's terminal. The data is translated/decoded by the web browser to recreate the audiovisual presentation of the web page on the user terminal's display. The user is able to navigate between different web pages on the website (a web page is a distinct sub-area of a website, like a page in a book) by selecting links (a selectable option/function that causes the loading of a different web page identified in the link coding) using browser navigation commands or the like.

Web pages oftentimes contain a large amount of data content such as text, graphics, pictures, video, and the like. The degree of content organization may vary, and web pages are often very lengthy, such that a user has to scroll down through the web page, much like a lengthy text document in a word processing program. As such, it can be difficult for users to find desired content/information in a given web page. While browser programs such as Microsoft Internet Explorer™ and Apple Safari™ have “find” functions, these only allow a user to search for text strings in a serial manner. In particular, the user selects the “find” option (e.g., from a pull-down menu), types in a string of text, and initiates the find function. The browser looks through the web page text, starting at the top of the page, and highlights the first instance of the text string that it finds, if any. At that time, the user can choose to either terminate the function, or to continue searching by selecting a “find again” option for the browser to highlight the next instance of the text string in the web page. Although such a function allows the user to find a text string, time may be wasted by having to repeatedly select the “find again” function. Additionally, since the “find” function is serial, users have no flexibility in navigating through the find results. Additionally, the “find” function is limited to text strings only, and there are no options for finding data/information according to different formats or types (e.g., other than simple text formatting such as bold or italics). Moreover, there are no options for manipulating the “find” results other than canceling the function and using a “cut and paste” operation for copying the text for use elsewhere.

### SUMMARY OF THE INVENTION

An embodiment of the present invention relates to a system and method for augmenting website data displayed on a terminal, e.g., for highlighting and adding commentary to network web page content data. By “terminal,” it is meant an electronic device capable of communicating with other devices over a network, including, for example, computers and wireless units such as mobile phones, wireless PDA's, wireless devices with high-speed data transfer capabilities, such as those compliant with “3-G” or “4-G” standards, “WiFi”-equipped computer terminals, and the like. Initially, website data is searched according to at least one user-selected search criterion. “Website data” includes both encoded website-related data as stored in memory, and displayed/executed decoded website-related data. The criterion might include, for example, one or more search terms and one or more search operators or instructions. Depending on the data and the search criteria, the search may yield a plurality of search results. By “search result,” it is meant an instance of website data meeting the search criteria. The search results are concurrently or simultaneously highlighted in the displayed data, by which it is meant that the search results are highlighted in the displayed website data at the same time. The website data may be obtained from a server terminal over a network, e.g., the Internet, using a web browser program.

In another embodiment, an index of the search results is generated and displayed. Each of the indexed search results is linked with a corresponding highlighted search result displayed in the website data.

In another embodiment, a user-selected one of the search results is removed from the grouping of search results, including de-highlighting the selected/removed search result from the displayed website data.

In another embodiment, a user selects one of the search results, and then enters comment data, e.g., text commenting on or otherwise relating to the selected search result. The comment data is associated with the selected search result, e.g., the comment data is logically linked to the selected search result. The comment data may be displayed along with the displayed website data.

In another embodiment, the index, search results, and/or comment data are stored as one or more files in conjunction with the website data. The file(s) is configured for subsequent retrieval for displaying the website data, index, search results, and/or comment data.

In another embodiment, an enhanced web page content search system is implemented on or as part of a web browser application (e.g., as a browser “plug-in”) for highlighting and adding commentary to web page content displayed on a terminal. The system includes a user interface and a search engine, and provides enhanced search functionality, e.g., flexible formatting, data-type, and other search options. After a user accesses a website, initiates operation of the system, and enters search criteria, the search engine conducts a search of the accessed website content. All the search results are highlighted concurrently. The user is provided with options for navigating through the search results (e.g., a search index), for adding selected displayed content to the search results and/or for removing selected search results, and for adding comments to the web page content. The highlighted and/or commented web page (including the original web page content and structure) is stored locally for subsequent retrieval and use.

### BRIEF DESCRIPTION OF THE DRAWINGS

The present invention will be better understood from reading the following description of non-limiting embodiments, with reference to the attached drawings, wherein below:

FIG. 1 is a schematic view of an enhanced web page content search system, according to an embodiment of the present invention, in the context of a communication network such as the Internet;

FIG. 2 is a detailed schematic view of the search system;

FIG. 3 is a schematic view showing a “comments” feature of the system;

FIG. 4 is a schematic view of content printout according to an embodiment of the present invention; and

FIG. 5 is a flowchart showing operation of an embodiment of the search system.

### DETAILED DESCRIPTION

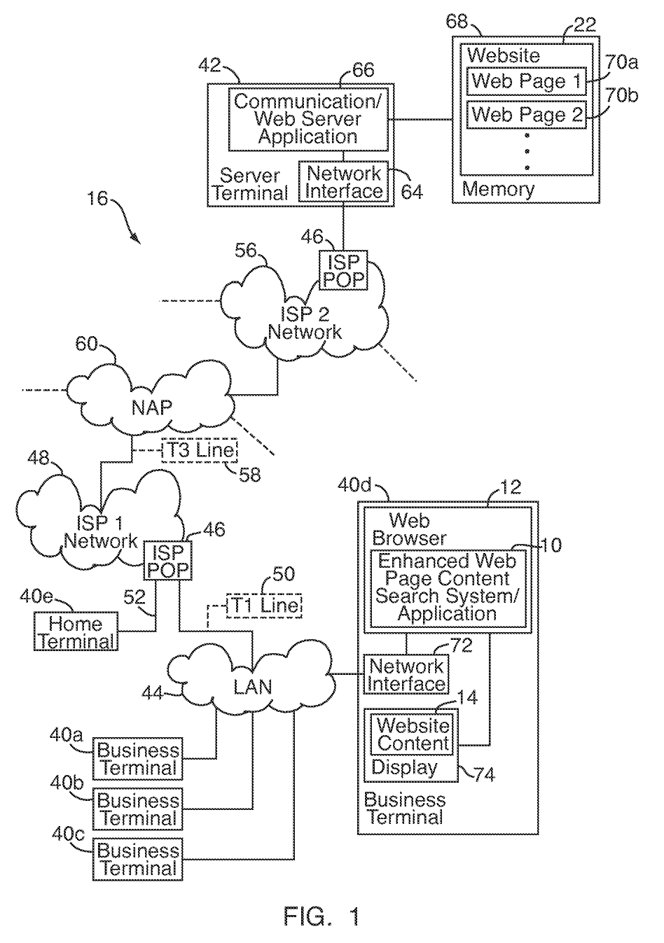

With reference to FIGS. 1-5, an enhanced web page content search system 10 is implemented on or as part of a web browser application 12 for highlighting and adding commentary to web page content 14 in a network 16. In effect, the system 10 acts as an enhanced “find” function for searching through and reviewing displayed website/web page data content 14, augmenting the existing functionality of the web browser application 12. The system 10 may be implemented as a browser “plug-in” module or application, and includes a user interface portion 18 and an enhanced search or!“find” engine 20. The system 10 provides functionality, accessed through the user interface 18, for searching through web page content according to flexible formatting, data-type, and search options. Once a user directs the web browser 12 to access a selected website 22, initiates operation of the system 10, and enters search criteria 24, the search engine 20 conducts a'search of the entirety of the accessed web page content 14 according to the search criteria 24. Subsequently, the system 10 highlights the search results 26 concurrently or simultaneously with one another, e.g., instances of web page content that meet the search criteria are highlighted at the same time. The user is provided with options 28 for navigating through the search results, options 30 for adding selected web page content to the search results and/or for removing selected highlighted web page content from the search results, and options 32 for adding local comments to the web page content. The user may then direct the system 10 to save the highlighted and/or commented web page (including the original web page content and structure) in local memory for subsequent retrieval and use.

The system 10, as noted, may be a plug-in module or supplemental application for use with a standard web browser program 12 such as Microsoft Internet Explorer™ and Apple Safari™. In either case, the system 10 would typically be implemented as a software program or suite of software programs configured for interfacing with the browser program. For a plug-in module, the system 10 would be obtained by the user (e.g., by downloading the system 10 from a network server terminal) and installed into the browser program 12 according to the plug-in interface of the browser. The system 10 would then be automatically available for use (e.g., through a pull-down menu system or the like) whenever the browser 12 was launched. For a supplemental application, the system 10 would be obtained in a similar manner, but would act as a “stand alone” utility program configured for separate activation apart from the browser. Once activated, however, the system 10 would work in conjunction with the browser, with user interface functionality either integrated with the browser's user interface and/or provided separately, e.g., in a “pop-up” window. (A pop-up window is a section of displayed content that appears or “pops up” in overlay of existing displayed content when an option for activating the window is selected using a mouse or otherwise. The pop-up window may contain informational content or a menu of commands, and typically remains displayed until it is deactivated or one of the menu options is chosen.) A browser program could also be outfitted with the system 10 in an initial instance, e.g., the system would be “built into” the browser for general distribution to all users of the browser.

Typically, the browser 12 and enhanced web page content search system 10 will be used in the context of accessing websites and other data content over an IP or other packet data network 16 such as the Internet. A simplified example of a typical Internet configuration is shown in FIG. 1. As indicated, the network 16 includes a number of client or end-user terminals 40a-40e and a number of server terminals 42 (only one is shown) for hosting network-available data content such as a website 22. Four of the terminals 40a-40d are interconnected by a LAN 44 (local area network), and could be, for example, terminals located in an office or other business setting. The LAN 44 is connected to an ISP (Internet service provider) POP (point of presence) 46, which is an access point for local users to access the ISP's network and/or other ISP infrastructure 48 (e.g., server terminals), through a local phone number, dedicated line, or the like. The LAN 44 may be connected to the ISP network using a T1 or other dedicated high bandwidth communication line 50. Other terminals, such as a home computer terminal 40e, are connected to the ISP POP 46 through a conventional phone line, DSL line, or cable modem line 52. The ISP network 48 is connected to other ISP networks or other networks 56 through high capacity lines 58 and network access points (“NAP,” also called Internet exchanges) 60, which are traffic exchange points in the routing hierarchy of the Internet. The interconnected networks 48, 56 together form the Internet 16.

In the network 16 shown in FIG. 1, a server terminal 42 is connected to the ISP network 56 through an ISP POP 46 or the like. The server terminal 42 includes a standard network interface 64 such as a network interface card, modem, cable modem, or the like, and web server application software or other communication software 66 for hosting a website 22. For example, the web server application 66 may process incoming requests for the website content and coordinate transmission of the website data to requesting terminals, in conjunction with the network interface 64. The website 22 is stored in terminal memory/data storage 68 as a set of encoded data (e.g., HTML-encoded data) functionally organized into web pages 70a, 70b. In addition, the client/user terminals 40a-40e each include a standard network interface 72 such a network interface card, cable modem, modem, or the like, a standard web browser 12, and a monitor or other display 74, among other standard components. The client/user terminals, web browser, server terminal, and website work in a standard manner as described above for users to connect to the Internet from the terminals 40a-40d and access and retrieve website data 76 from the server terminal 42. Once received at a terminal, e.g., terminal 40d, the HTML encoded website data (or other data) 76 is decoded for visually displaying or otherwise executing or using the website data content 14 on the terminal 40d and display 74. For example, visual website data is displayed for viewing, and audio data files are decoded (e.g., by an audio card/module) for playback over a speaker or other audio output means.

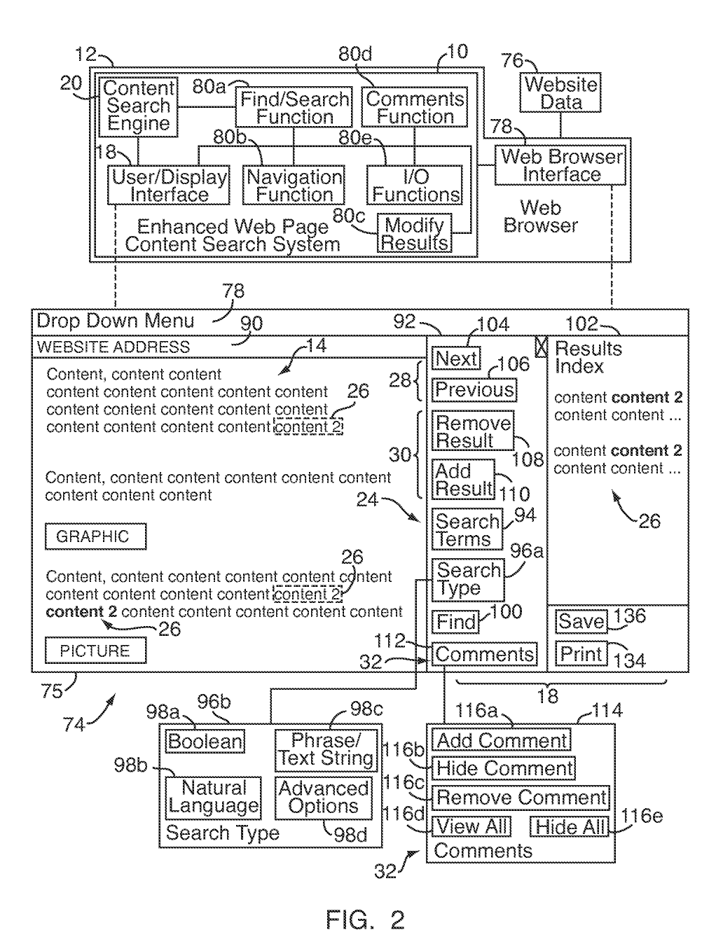

After launching the web browser 12 and accessing website data 76 for display of the website content 14 on the terminal's display 74, the user of the terminal 40d may activate the system 10 for carrying out an enhanced “find” function in the content 14. For example, the web browser 12 may include a user interface 78 such as a drop down menu displayed at the top of the display 74 above a window 75 containing the website data content 14. One of the options in the drop down menu 78 could be a standard “find” option, whereas another option in the drop down menu 78 could be an “enhanced find” option for initiating operation of the system 10. Once the system 10 is activated, the user will typically be presented with a user interface 18 containing a number of options for implementing the functionality of the system 10 under user direction. The user interface 18 could be separate from the web browser interface 78, or it could be part of the web browser interface 78. For example, the user interface 18 could be presented as separate pop-up windows as shown in FIG. 2, or it could be presented as an additional drop-down menu option/column in the drop-down menu interface 78. Other options include menu hierarchies, command line interfaces, “hot key” combinations, and the like. Also, the system 10 may be implemented in such a manner that a user does not have to explicitly launch or select the system 10 to activate its functional components. Instead, for example, the functional components could be provided as an “always on” portion of the web browser's user interface 78. One such option would be to have an-“enhanced find” drop-down menu, in addition to the other drop-down menu options of the web browser 12, wherein when the drop-down menu was selected the user would be presented with a drop-down list of the system options.

In addition to the user interface 18, the system 10 includes various functions, e.g., implemented as software subroutines, modules, or the like as part of the system programming, which are accessed through the user interface. These include a find/search function/module 80a, a results navigation function/module 80b, a modify results function/module 80c, a comments function/module 80d, and an input/output (“I/O”) function/module 80e enabling the printing and/or saving of files. These functional blocks will primarily be described herein with respect to the user interface options provided for accessing the functions. However, as should be appreciated, the user interface options would typically merely act as a means for initiating the functions, e.g., when a user selects a particular option in the user interface, the underlying functional blocks corresponding to the selected interface option, as implemented in code or otherwise, would be executed.

FIG. 2 shows one possible example of a user interface 18, acting in a complementary manner to a web browser interface 78, for displaying website data 76 (e.g., stored as HTML code on the terminal 40d) on a display 74. As indicated, the web browser interface 78 generates a drop-down menu 78 for accessing web browser functions, as well as other elements such as an Internet navigation bar and URL display window 90. The web browser 12 also decodes and displays the HTML (or otherwise) encoded data 76 as website data content 14, which may include text, graphics, pictures, video, sound, and the like. Once accessed, the system user interface 18 generates a pop-up functions menu 92, which includes the aforementioned options 28 for navigating through the search results, options 30 for adding selected web page content to the search results and/or removing selected highlighted web page content from the search results, and options 32 for adding local comments to the web page content, among others. (The various options described herein can be configured for user selection as “clickable” buttons or the like, selectable using a mouse or other pointer, according to computer programming methods well known in the art.)

To elaborate, depending on the desired level of functionality, the menu 92 will typically include one or more text-entry fields or windows 94 for entering search terms 24. For accessing advanced search/find options, the menu may include a “search type” option 96a, the selection of which could, for example, result in the generation of a “search type” pop-up window 96b. (In other words, clicking on the “search type” button 96b would result in the pop-up window 96b being shown on the display 74.) The window 96b would allow a user to select among different types or categories of find/search functions. Examples include a Boolean-logic search 98a (e.g., “AND,” “OR,” “NOT”), an “enhanced” Boolean-logic search, a natural language search 98b, a phrase or text string search 98c, or the like. A natural language search is a search using regular spoken language, such as a sentence that describes the information being looked for, where the search function uses a programmed logic to determine the keywords in the sentence by their position in the sentence, for search purposes. An enhanced Boolean search is one using both Boolean operators and additional operators such as word truncation symbols and proximity designators, for example, “word 1 w/5 word 2” designating a search for instances where “word 1” is within five words of “word 2.” The “search type” window 96b could also include an “advanced options” button 98d leading to a window allowing users to conduct searches according to (i) text formatting options, e.g., font, style, and size, (ii) non-text data objects such as pictures, graphics, sound, and video, and (iii) combined fields of search, that is, combining a number of different search terms each with different formatting and/or content options.

Once a user enters the search terms 24, the user clicks on or otherwise selects a “find” or “search” button 100 to initiate the search function. The content search engine 20 searches through the website data 76 and/or displayed content 14 according to the entered search terms 24 and other search criteria, such as selected formatting or advanced options or the like. (Since the design and operation of search engines are well known in the art, further detail about the internal operation and design of the search engine 20 is not provided herein.) A display interface portion of the system (e.g., part of the user interface 18 or otherwise, configured to interact with the web browser 12, display 74, terminal display driver, and/or the like for causing graphic elements to be displayed) then makes the search results 26 available to the user on the display 74. By “search result,” it is meant an instance of website data or displayed content that meets the selected search criteria. This can be done in several ways. For example, the results 26 can be highlighted on the display 74, using text bolding (where applicable), outlining, coloration/shading, graphic pointers, or the like. In the system 10, all the search results will typically be highlighted concurrently. Additionally, the results 26 may be displayed in a results index 102 provided in a window or otherwise. The index 102 would include each search result 26 along with some surrounding data content to show context, listed in webpage order (or as otherwise selected by the user), and possibly showing relative position such as an index number, page/frame number, section, or the like. Typically, each index entry would be linked to the displayed content 14, whereby a user could select an index entry and the displayed content 14 would be repositioned centered about the selected index result.

The functions menu 92 may also include navigation options 28 such as a “next” button 104, a “previous” button 106, and the like. For these functions, one of the search results 26 (in the index 102 and/or in the displayed content 14) would be specially highlighted as an “active” or selected result. Clicking the “next” button 104 would move the display to the next search result following the active result, with that search result becoming the new active search result. The “previous” button 106 would work in a similar manner, but with respect to prior/previous search results.

The functions menu 92 may also include options 30 to modify the search results 26. For example, there may be a “remove result” button 108 and an “add result” button 110. To explain further, after a search/find is carried out, it may be the case that some of the results are not relevant to the user's needs. The irrelevant results may make it more difficult and time consuming for the user to review the results, either at the present time or if the web page is later accessed. Accordingly, the “remove result” button 108 allows a user to select one of the search results and remove it from the grouping or set of search results, including de-highlighting the selected result and removing it from the index. For example, the user could click on the irrelevant search result (thereby designating it as the active search result) and then select the “remove result” function 108. In other cases, it is possible that the search did not find all relevant material in the content 14, but that the user notices the relevant material while reviewing the content 14 and/or search results 26. To add this material as a search result 26, the user would select the material of interest (using a mouse or other pointer) and then click on the “add result” button 110. The selected material would then be highlighted according to the highlighting format used in the system 10 to indicate or designate the search results, and/or added to the index 102.

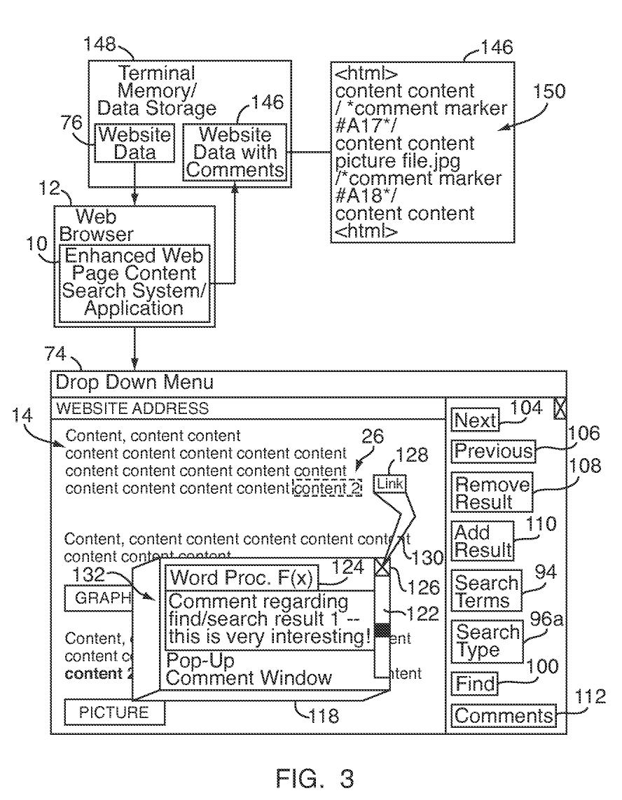

The functions menu 92 may also include a “comments” button 112 for accessing the comments function 32. As noted, the comments function allows a user to add local comments to the website data 14, 76. (By “local” comment, it is meant that the comment is displayed and possibly stored in association with the website data on the terminal 40d, but not at the source/server terminal 42 where the website data originated.) Clicking on or otherwise selecting the button 112 may result, for example, in the display of a “comments” pop-up window 114. The window 114 contains a menu of options such as an “add comment” button 116a, a “hide comment” button 116b, a “remove comment” button 116c, a “view all” button 116d, a “hide all” button 116e, and the like. After selecting one of the search results 26, e.g., by clicking on the search result to designate it as the active or current search result, selecting the “add comment” button 116a initiates the comments function 80d, thereby allowing a user to associate text, graphics, or other comment data with the selected/active search result 26. In particular, selecting the button 116a causes the display of a text-entry and comment display window 118, as shown in FIG. 3. The window 118 includes an area 120 for the entry of text and other material, navigation functions 122 such as a scroll bar, one or more menus 124 containing word processing functions (“word proc. F(x)”), and possible commands/options for exiting the window 118 such as a “close window” button 126. Also displayed are a link graphic 128 near the selected result 26, and possibly a graphic element 130 connecting the link graphic 128 to the window 118. The index entry for the selected result 26 (if the system 10 includes an index 102) may also be provided with a graphic indicating the presence of a comment in association with the selected result 26. The graphics 128, 130 distinctly point out with which result the comment is associated, for easy user reference. Once the window 118 is displayed, the user enters comment text or other data or information 132 (“comment data”) into the text-entry area 120, which can be formatted or modified using the word processing functions 124. The comment window 118 will typically remain displayed until the user selects the close window button 126 or the “hide comment” button 116b, including tracking along with the selected result 26 if the content 14 is scrolled so that the selected result 26 is no longer displayed. (In other words, the comment window is kept in active video memory such that when the active result 26 is scrolled out of view and then back into view on the display 74, the comment window is also displayed.) This allows the user to view the comment window while accessing or reviewing other displayed data 14. Additionally, the comments window 118 may be configured for user selection and movement about the window 75 of displayed content 14, with the graphic 130 optionally tracking along with the moved window for the window to remain graphically connected to the link graphic 128. (As should be appreciated, although the comments pop-up window 114 is not shown in FIG. 3, it may remain displayed as shown in FIG. 2 while the user is accessing/using the comments feature.)

The “remove comment” button 116c allows a user to delete a comment 118. For example, the user may access a particular comment and then select the button 116c for deleting the comment. Alternatively, the window 118 itself may have such an option. Additionally, the “view all” and “hide all” buttons 116d, 116e, respectively, allow a user to cause all comments to be shown (the “view all” button) and all currently displayed comments to be hidden from view (the “hide all” button). Similar functions and options are possible. When a comment is added and subsequently closed or hidden, the comment is automatically saved in memory, in relation to the search result with which it was originally associated. Typically, the link graphic 128 will remain displayed proximate to the search result as a graphic indication to the user of the comment's “presence,” e.g., association with the search result. To view a comment window 118 that is currently hidden from view, the user may use the “view all” button 116d. Alternatively, for displaying a single comment, the user simply selects the relevant link graphic 128, which causes the comment window 118 to appear, including the added comment data 132.

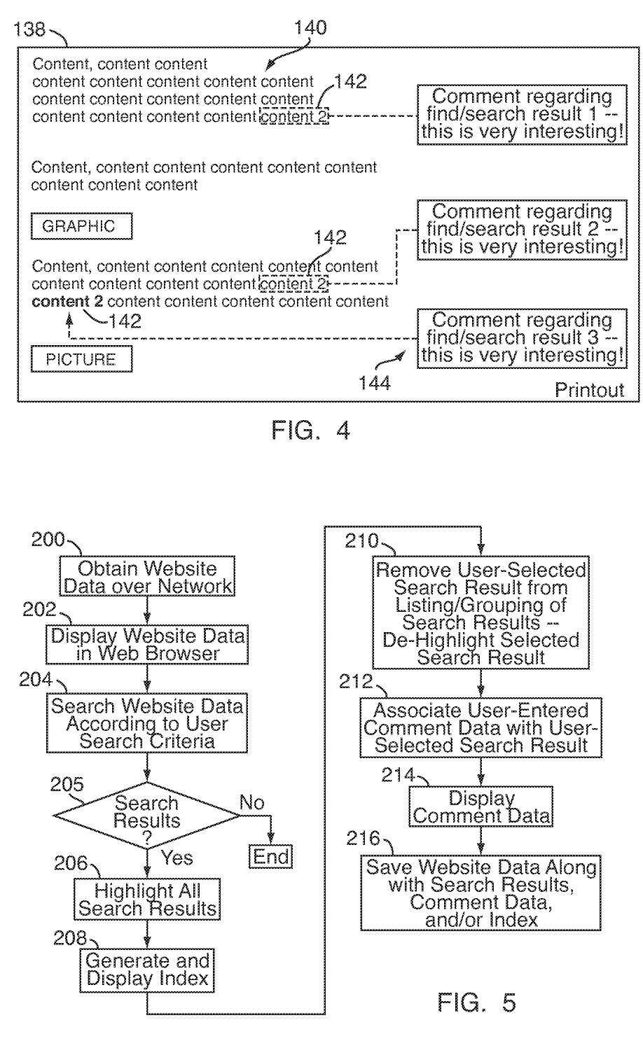

Referring back to FIG. 2, the functions menu 92 may also include a “print” option 134 and a “save” option 136 for initiating the I/O functions 80e. Selecting the print option 134 would cause the display of a print-related menu (not shown) having standard options for printing or otherwise creating a hard copy of the displayed content 14, comments 118, and/or search results 26. For example, the user could be provided with options for selecting a particular printer and paper source. Additionally, the user could opt to (i) print only the content 14, (ii) print the content 14 with search results 26, (iii) print only the index 102, (iv) print only the comments 118, (v) print the comments, results, and content 14 together, (vi) etc. An example of the latter is shown in FIG. 4. There, a printout 138 includes printed material 140 corresponding to the displayed web page content 14, printed material 142 corresponding to the highlighted search results 26, and printed material 144 corresponding to the comment data 132 associated with the search results.

The “save” option 136 allows a user to save and/or load a data file 146 (see FIG. 3) that includes the website data 76 in conjunction with the search results 26 (or, more specifically, data associated with the search results) and the comment data 132. The file 146 may be saved in terminal memory or other data storage 148. Thus, the user is able to save the search results and comments, in association with the web page data 76, such that when the file is later loaded, the same information is displayed (e.g., as in FIG. 2) as was previously, including being able to access all the functions of the system 10 and browser 12 for further review and augmentation of the content 14. The search result data and comment data 132 may be augmented with the web page data 76 for storage and retrieval, so as to replicate the original display when the file is subsequently loaded, in a number of ways. For example, the HTML encoded data 76 could be interspersed with one or more specially-formatted comments 150, each of which links to a sub-file or grouped data record containing information about (i) the search results, (ii) the comment data, and (iii) with which search results the comment data was associated. Alternatively, the original website data file 76 could be linked to a file containing similar information, e.g., which portions of the data were classified as search results, which results had associated comments, and what the comments contained. When the file 146 is loaded, the system 10 translates the file 146 (or group of files or other associated data elements) for re-generating the displayed web page contents 14 along with the search results 26 and comment windows 118 and comment data 132.

The system 10 of the present invention is suitable for implementation on various types of terminals 40a-40e where websites and other data are accessed over a network 16, including, for example, computer terminals and wireless units such as mobile phones, wireless PDA's, wireless devices with high-speed data transfer capabilities, such as those compliant with “3-G” or “4-G” standards, “WiFi”-equipped computer terminals, and the like. The network 16 may include, for example, wire-line networks such as DSL networks, public switched telephone networks (PSTN), IP (Internet protocol)-based networks such as the Internet or other packet data networks, local area networks (LAN), and wireless networks such as those using CDMA, GSM, IEEE 802.11x, and/or UMTS communications or the like. In a typical case, the system 10 will be used on a terminal in conjunction with a web browser application or similar application for accessing the Internet.

The system 10 may be further configured for a user to control the effect of subsequent searches on a previous search. Examples include: (i) a new search erases a previous search; (ii) a new search results in a copy of the web page being generated in a new browser window, with the new search being carried out in the newly generated window; (iii) a new search augments the previous search, e.g., all search results are shown together; and (iv) upon commencing a new search, the prior search is saved and kept as a background listing or option, with the user being able to toggle between the current search and prior search(es).

In operation, the system 10 can be characterized as carrying out a method for augmenting website data displayed on a terminal 40d. With reference to FIG. 5, at Step 200 website data 22 is obtained from a server terminal 42 over a network 16 and stored locally (e.g., as website data 76). At Step 202, the website data 76 is decoded for displaying the website content 14 using a web browser program 12 running on the terminal 40d. (That is, the data 76 is decoded through the browser 12, resulting in the displayed content 14.) At Steps 204 and 205, the search engine 20 searches the website data 76 according to user-selected search criteria 24. If any portion(s).of the data 76 meet the criteria, this yields or results in one or more search results 26. At Step 206, the search results 26 are concurrently highlighted in the displayed website data 14. At Step 208, the system 10 optionally generates and displays an index 102 of the search results 26. The indexed search results are linked with corresponding highlighted search results displayed in the website data 14. At Step 210, the system 10 optionally removes a user-selected one of the search results from the grouping/plurality of original search results, with the search result being de-highlighted in the displayed website data. Similarly, the system may add a user-selected portion of the website data (not included in the original grouping/plurality of search results) to the search results, with the selected portion being highlighted as a search result in the displayed website data. At Step 212, user-entered comment data is associated with user-selected search results, that is, the user selects a search results and enters comment data, which the system then associates with the selected search result, e.g., the comment is linked to the search result. At Step 214, the comment data is displayed along with the website data. At Step 216, the system saves the index, search results, and/or comments in conjunction with the website data as one or more files, which are stored in terminal memory. The file(s) may be accessed later for re-accessing and displaying the website data along with the index, search results, and comments.

Since certain changes may be made in the above-described method and system for highlighting and adding commentary to network web page content, without departing from the spirit and scope of the invention herein involved, it is intended that all of the subject matter of the above description or shown in the accompanying drawings shall be interpreted merely as examples illustrating the inventive concept herein and shall not be construed as limiting the invention.

We claim:

1. A method for augmenting website data on a terminal, said method comprising the steps of:
searching said website data according to at least-one user-selected search criterion, said search yielding a plurality of search results; and
highlighting said plurality of search results in a displayed portion of said website data at the same time.

2. The method of claim 1 further comprising:
obtaining said website data from a server terminal over a network, wherein said displayed portion of the website data is displayed through a web browser program running on the terminal.

3. The method of claim 2 further comprising:
generating and displaying an index of said search results, each of said indexed search results being linked with a corresponding one of said highlighted search results.

4. The method of claim 3 further comprising:
saving at least one of said index and said search results in conjunction with said website data as at least one file stored on said terminal, said at least one file being configured for subsequent retrieval to display said displayed portion of the website data and said at least one of said ₁index and said search results.

5. The method of claim 2 further comprising:
removing a user-selected one of said search results from said plurality of search results, wherein the removed search result is de-highlighted in said displayed website data.

6. The method of claim 2 further comprising:
adding a user-selected portion of said displayed website data not included in said plurality of search results to said plurality of search results, wherein the selected portion added to the plurality of search results is highlighted in said displayed website data.

7. The method of claim 2 further comprising:
removing a user-selected one of said search results from said plurality of search results, wherein the removed search result is de-highlighted in said displayed website data; and
adding a user-selected portion of said displayed website data not included in said plurality of search results to said plurality of search results, wherein the selected portion added to the plurality of search results is highlighted in said displayed website data.

8. The method of claim 2 further comprising:
associating user-entered comment data with a user-selected one of said plurality of search results; and
displaying said comment data on said displayed website data.

9. The method of claim 8 further comprising:
saving said comment data and said search results in conjunction with said website data as at least one file stored on said terminal, said at least one file being configured for subsequent retrieval to display said displayed portion of the website data, said comment data, and said search results.

10. The method of claim 8 further comprising:
displaying at least one graphic element linking said displayed comment data with said user-selected one of said plurality of search results.

11. The method of claim 10 further comprising:
displaying said displayed comment data and at least a portion of said at least one graphic element in a different area of a display of said terminal than where said displayed comment data and said at least a portion of said at least one graphic element were previously displayed, according to at least one user control input.

12. The method of claim 2 further comprising:
removing a user-selected one of said search results from said plurality of search results, wherein the removed search result is de-highlighted in said displayed website data;
associating user-entered comment data with a user-selected one of said plurality of search results; and
displaying said comment data on said displayed website data.

13. The method of claim 12 further comprising:
saving said comment data and said search results in conjunction with said website data as at least one file stored on said terminal, said at least one file being configured for subsequent retrieval to display said displayed portion of said website data, said comment data, and said search results.

14. The method of claim 12 further comprising:
adding a user-selected portion of said displayed Website data not included in said plurality of search results to said plurality of search results, wherein the selected portion added to the plurality of search results is highlighted in said displayed website data;
generating and displaying an index of said search results, each of said indexed search results being linked with a corresponding one of said highlighted search results; and
saving said comment data, said search results, and said index in conjunction with said website data as at least one file stored on said terminal, said at least one file being configured for subsequent retrieval to display said displayed portion of the website data, said comment data, said search results, and said index.

15. A method for augmenting data on a terminal, said method comprising the steps of:
searching said data according to at least one user-selected search criterion, said search yielding a plurality of search results;
simultaneously highlighting said plurality of search results in a displayed portion of said data; and
removing a user-selected one of said search results from said plurality of search results, wherein the removed search result is de-highlighted in said displayed data.

16. The method of claim 15 further comprising:
associating user-entered comment data with a user-selected one of said plurality of search results; and
displaying said comment data on said displayed data.

17. The method of claim 16 further comprising:
saving said comment data and said search results in conjunction with said searched data as at least one file stored on said terminal, said at least one file being configured for subsequent retrieval to display said displayed portion of the data, said comment data, and said search results.

18. A web page content search system comprising:
a search engine running on a terminal, said search engine being configured to search web page data stored on said terminal according to user-selected search criteria; and
a display interface cooperative with said search engine and configured to simultaneously highlight all of a plurality of search results generated by said search engine in a displayed portion of said web page data.

19. The system of claim 18 further comprising:
a user interface cooperative with said display interface and configured for user selection of a first one of said plurality of highlighted search results for removing said first search result from said plurality of search results, wherein the removed search result is de-highlighted in the displayed portion of said web page data, and said user interface being further configured for user entry of comment data in association with a user selected second one of said plurality of highlighted search results.

20. The system of claim 19 further comprising:
an input/output module configured to save said comment data and said search results in conjunction with said web page data as at least one file stored on said terminal, said at least one file being configured for subsequent retrieval by said input/output module and use by said display interface to display said website data, said comment data, and said search results.
